(19) United States
(12) Patent Application Publication
(10) Pub. No.: US 2008/0050098 A1
(43) Pub. Date: Feb. 28, 2008

(54) RECORDING APPARATUS

(75) Inventors: Satoshi Okamura, Yokohama-shi (JP); Akihito Ishihara, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/838,062

(22) Filed: Aug. 13, 2007

(30) Foreign Application Priority Data
Aug. 28, 2006 (JP) 2006-231013
Aug. 28, 2006 (JP) 2006-231017

(51) Int. Cl. H04N 7/26

(52) U.S. Cl. 386/124

(57) ABSTRACT

An imaging apparatus includes an imaging unit having a first mode for generating a first video signal according to a first video signal format, and a second mode for generating a second video signal according to a second video signal format. The image apparatus includes a selection unit to select either a first recording format corresponding to the first video signal format or a second recording format corresponding to the second video signal format to initialize a recording medium, and an initialization unit to perform an initialization process of the recording medium according to the selected recording format. The image apparatus further includes a recording unit to record either the first video signal or the second video signal on the initialized recording medium, and a control unit to select one of the modes of the imaging unit depending on the selected recording format.

### BACKGROUND OF THE INVENTION

1. Field of the Invention

The present invention relates to a recording apparatus and an imaging apparatus (e.g., video camera). More particularly, the invention relates to an initialization process performed on a recording medium (e.g., optical disc) of a video camera.

2. Description of the Related Art

Conventionally, video cameras which capture video images and record the captured images on an optical disc have been known. As the optical disc (disc) used in such video cameras, digital versatile discs (DVDs) have been known. The DVDs for a recording purpose includes, for example, write-once discs such as a digital versatile disc-recordable (DVD-R), and rewritable discs such as a digital versatile disc-rewritable (DVD-RW). With respect to recording formats for recording video signals on these DVDs, DVD-Video format and DVD Video Recording (VR) format are used. As discussed in Japanese Patent Laid-Open No. 2003-78874, the disc video camera performs an initialization process corresponding to such recording formats when a disc is mounted for the first time.

Further, as discussed in Japanese Patent Laid-Open No. 2005-243071, if a disc has not been initialized at recording start time, a disc video camera temporarily can store a video signal and an audio signal on a memory. Meanwhile, an initialization process of the disc is automatically performed. After the process is completed, the recording of the information temporarily stored on the memory is started.

The various data recorded on the discs as described above is generally used as files. Accordingly, a file system can be used to manage the data recorded on the discs as files. With respect to the file system for the data recorded on the discs, Universal Disc Format (UDF) is known. DVD-Rs and DVD-RWs can be used in the file system of the UDF 2.0 standard.

In the disc video camera, before the video signal or the audio signal can be recorded on the disc, a file formatting process and a disc formatting process are typically performed to prepare for the writing of the data on the disc.

Further, in recent years, devices such as TV monitors which are compatible with a high definition (HD) video signal, instead of standard definition (SD), have been developed.

When a high-definition video signal or an audio signal such as the HD signal is recorded on the disc, from a point of portability and miniaturization of the camera, it is difficult to use a disc greater than a conventional 8 cm disc in the video camera. Therefore, codecs which have a high compression rate, for example, MPEG-4 AVC (H.264) standard, are used to prevent bit rates from increasing in recording the high-definition video signal and audio signal on the disc of the conventional size.

However, the UDF 2.0 which is the file format used in the current DVD recording is not compatible with the standards of the HDTV video and audio signals. Accordingly, a new file format compatible with the HDTV standards is desired.

However, in order to record video images for long hours, the resolution of the video images needs to be lowered to the SDTV or the compression rate needs to be lowered to perform a low bit rate compression. Further, when reproduction is performed in a different type of reproduction device, it is useful that the DVD recording is performed using the current MPEG-2 standard at the resolution of the SDTV so that compatibility is maintained.

Consequently, in recent years, an Advanced Video Codec High Definition (AVCHD) standard for capturing a HD video signal and recording the signal on a recording medium such as a DVD has been discussed.

According to the AVCHD standard, HD signals can be recorded on DVDs. Thus, video cameras which can perform recording using the AVCHD format on the DVDs in addition to the conventional DVD video format and the VR format for recording SD signals on the DVDs can be realized.

As a result, such a type of the video camera operates on a plurality of disc types, recording formats, and recordable video signal formats. Accordingly, if combinations thereof are not appropriately selected, it may not be possible to record the video signal or the audio signal on the DVD.

Especially, with respect to the file formats, once a recording medium is initialized according to a specific format, in subsequent recording operations, it may not be possible to record data using a different format. Needless to say, if a recording medium of a disc format in which initialization can be performed again is used, recording can be performed when the recording medium is initialized according to the different file format. However, in such a case, all contents recorded before the initialization may be erased.

### SUMMARY OF THE INVENTION

According to an aspect of the present invention, an imaging apparatus includes an imaging unit configured to generate a first video signal according to a first video signal format, and a second video signal according to a second video signal format, in which the imaging unit includes a first mode for generating the first video signal and a second mode for generating the second video signal, an initialization format selection unit configured to select either a first recording format corresponding to the first video signal format or a second recording format corresponding to the second video signal format to initialize a recording medium, an initialization unit configured to perform an initialization process of the recording medium according to the recording format selected by the initialization format selection unit, a recording unit configured to record either the first video signal or the second video signal on the recording medium initialized by the initialization unit, and a control unit configured to select one of the modes of the imaging unit depending on the recording format selected by the initialization format selection unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a view illustrating a configuration of a video camera according to an exemplary embodiment of the present invention.

FIG. 2 is a view illustrating combinations of disc recording formats and camera modes.

FIG. 3 is a flowchart illustrating a process performed when a disc is mounted according to an exemplary embodiment of the present invention.

FIGS. 4A to 4E are views illustrating display screens in formatting processes.

FIG. 5 is a view illustrating recording format information.

FIG. 6 is a flowchart illustrating a process performed when a disc is mounted according to an exemplary embodiment of the present invention.

FIG. 7 is a flowchart illustrating a process performed when a disc is mounted according to an exemplary embodiment of the present invention.

FIGS. 8A and 8B are views illustrating display screens in formatting processes.

FIG. 9 is a view illustrating a configuration of a video camera according to an exemplary embodiment of the present invention.

### DETAILED DESCRIPTION OF THE EXEMPLARY EMBODIMENTS

Embodiments of the invention will be described in detail below with reference to the drawings.

### First Exemplary Embodiment

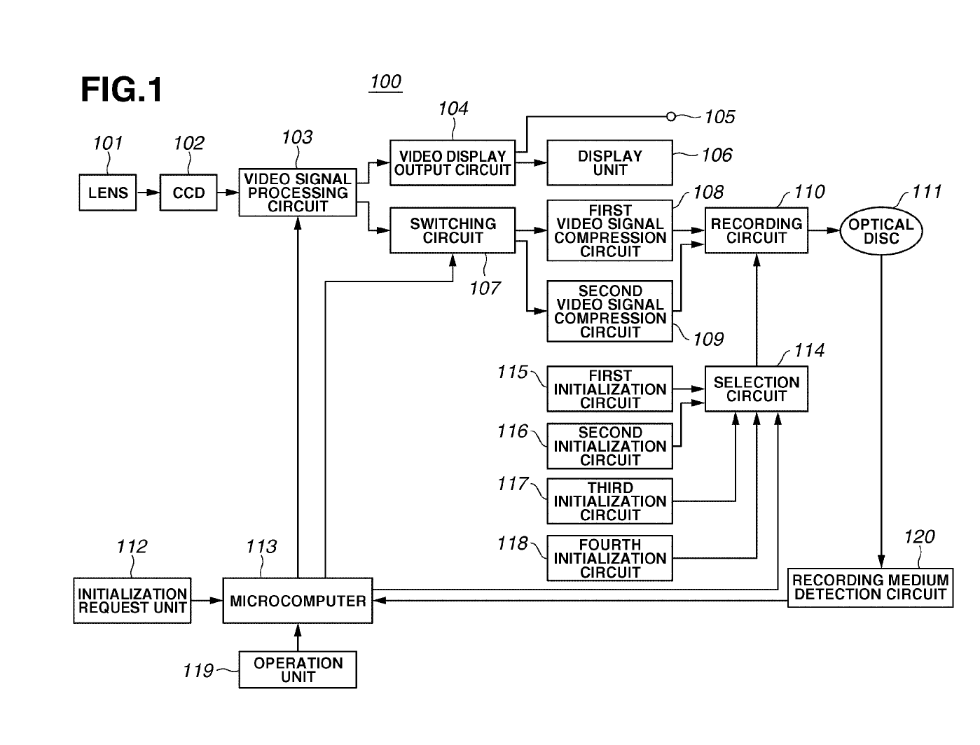

FIG. 1 is a view illustrating an exemplary configuration of a video camera 100 which uses an optical disc as a recording medium according to a first exemplary embodiment of the present invention.

In FIG. 1, reference numeral 101 denotes a lens, and a solid-state image sensing device 102 is a charge-coupled device (CCD). A video signal processing circuit 103 converts an image signal into a video signal, and a video display output circuit 104 outputs the video signal to a display device or an output terminal.

Reference numeral 105 denotes a video output terminal and reference numeral 106 denotes a display unit. A switching circuit 107 switches compression formats of the video signal. A first video signal compression circuit 108 codes a video signal according to a predetermined coding format to compress the information volume. A second video signal compression circuit 109 codes a video signal according to a coding format different from that of the first video signal compression circuit 108 to compress the information volume. A recording circuit 110 records the compressed video signal on a recording medium, and an optical disc 111 is a recording medium.

Reference numeral 112 denotes an initialization request unit and a microcomputer 113 performs system control of a disc camcorder. A selection circuit 114 selects a type of a recording format when the optical disc 111 is initialized. A first initialization circuit 115, a second initialization circuit 116, a third initialization circuit 117, and a fourth initialization circuit 118 respectively initialize the optical disc 111 according to respective different formats. An operation unit 119 includes various operation switches. The operation switch 119 includes a power switch, a changing-over switch for switching between a recording mode and a reproduction mode, an eject switch for ejecting the disc, a recording trigger switch, a display switch for displaying a menu screen, a move switch for moving to a menu item, and a selection switch. By operating the operation switch, users can switch camera modes in the video camera 100 between a HD mode and a SD mode as described below. A recording medium detection circuit 120 detects the optical disc 111.

An object image formed using the lens 101 is photoelectrically converted into an electrical signal in the CCD 102. Then, the electrical signal is converted into a video signal in the video signal processing circuit 103. The video signal processing circuit 103, according to an instruction from the microcomputer 113, generates a menu screen for displaying a status of the camcorder and performing various settings and displays the menu screen on the display unit 106.

The video signal output from the video signal processing circuit 103 is supplied to the video display output circuit 104 and the switching circuit 107. The video display output circuit 104 processes the input video signal, converts the signal into a format appropriate for output, and outputs the converted signal through the video output terminal 105 to the outside. Further, the video display output circuit 104 outputs the video signal or the menu screen to the display unit 106 to display the data.

The switching circuit 107 outputs the input video signal either to the first video signal compression circuit 108 or the second video signal compression circuit 109 according to an instruction from the microcomputer 113.

The first video signal compression circuit 108 and the second video signal compression circuit 109 compress the video signal using different compression formats. The first video signal compression circuit 108 employs the MPEG-4 AVC (H.264) format which corresponds to the AVCHD standard as the compression format, and compresses a HDTV video signal. On the other hand, the second video signal compression circuit 109 employs the MPEG-2 format as the compression format, and compresses a SDTV video signal.

The video signal output from the video signal processing circuit 103 corresponds to the HDTV. Accordingly, the second video signal compression circuit 109 includes a down conversion circuit which converts the HDTV signal to the SDTV signal before the compression of the signal.

The compressed video signal is recorded by the recording circuit 110 on the optical disc 111. The recording circuit 110 converts the video signal into a predetermined format which corresponds to the recording format. Based on the converted data, a pick-up unit (not shown) emits laser beam to the optical disc 111 and the data is recorded on the optical disc 111.

The recording circuit 110 includes a spindle motor which revolves the optical disc 111, the pick-up unit which emits the laser beam, and a seek motor which drives the pick-up unit, and a motor driver.

When recording is performed, laser beam is emitted onto a recording layer of the optical disc 111 such as a DVD-R or a DVD-RW and data is recorded. When reproduction is performed, the laser beam is emitted onto the recording layer, and the reflected light is detected by the pick-up unit. Thus, the information is read.

The recording medium detection circuit 120 reads the data recorded on the optical disc 111, and outputs the data to the microcomputer 113. The microcomputer 113, based on the data output by the recording medium detection circuit 120, determines whether the optical disc 111 is mounted, and whether the optical disc 111 is initialized. Further, if the optical disc 111 is already initialized, the microcomputer 113 determines the type of the recording format.

The selection circuit 114 selects one initialization circuit out of the four initialization circuits 115 to 118. The first initialization circuit 115, the second initialization circuit 116, the third initialization circuit 117, and the fourth initialization circuit 118 output initialization data for initializing the optical disc 111 using the different formats to the recording circuit 110 respectively. The recording circuit 110 records the initialization data on the optical disc 111 when the initialization process is performed.

The initialization request unit 112 includes a switch configured to select a formatting type using the displayed menu screen output from the video output terminal 105 or a menu screen displayed on the display unit 106, and to instruct to start the formatting. The recording format selection result and the initialization start instruction by the initialization request unit 112 are output to the microcomputer 113.

Hereinafter, combinations of camera modes (video signal formats for recording with the video camera 100), video compression formats, file formats of the optical disc 111 and recording formats of signals according to an exemplary embodiment will be described. The video camera 100 includes, as the camera modes, an SD mode which is used to record an SD signal and an HD mode which is used to record an HD signal. Users can set a camera mode between the SD mode and the HD mode by operating the operation unit 119. The information about the set camera mode is stored on a nonvolatile memory within the microcomputer 113.

In an exemplary embodiment, the video signal can be recorded according to either type of formats, that is, the DVD format or the AVCHD format.

The DVD format employs the MPEG-2 format as the compression format of the video signal and employs the UDF 2.0 as the file format of the optical disc 111. Since the SD signal is recorded in the DVD format, between the HD mode and the SD mode, the SD mode corresponds to the DVD format as the camera mode.

On the other hand, the AVCHD format employs the MPEG-4 AVC (H.264) format as the compression format of the video signal and employs the UDF 2.5 as the file format of the optical disc 111. Since the HD signal is recorded in the AVCHD format, between the HD mode and the SD mode, the HD mode corresponds to the AVCHD format as the camera mode.

As described above, the differences of the recording formats correspond to the differences of the file formats. In the respective recording formats, a disk format can be selected between the DVD video format and the VR format.

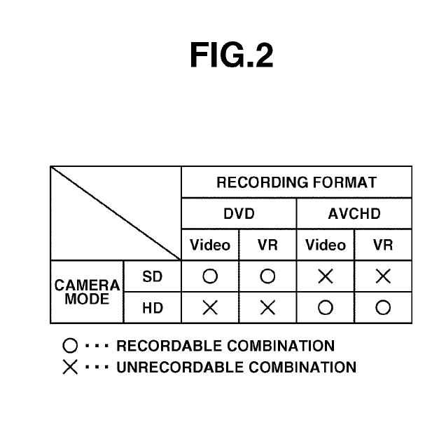

FIG. 2 is a view illustrating combinations which enable recording of the respective camera modes, the recording formats and the disc formats. In the drawing, “O” denotes the combinations which enable recording, and “X” denotes the combinations which do not enable recording.

As shown in FIG. 2, there are eight combinations. However, when the DVD format is selected as the recording format, only the SD mode can be selected as the camera mode. On the other hand, if the AVCHD format is selected, only the HD mode can be selected as the camera mode. Thus, when the recording format of the optical disc 111 is determined, the camera mode is determined.

When the optical disc 111 is mounted on the video camera 100, the recording medium detection circuit 120 reads data on a predetermined region of the disc. Then, the recording medium detection circuit 120 sends disc information including the file format type, and information whether the optical disc is initialized, to the microcomputer 113.

The selection circuit 114 selects a circuit to be used for the initialization process out of the first initialization circuit 115 to the fourth initialization circuit 118.

The first initialization circuit 115 performs a file formatting process according to the UDF 2.0 for the DVD format recording, and performs a disc formatting process according to the DVD-video format.

The second initialization circuit 116 performs a file formatting process according to the UDF 2.0 for the DVD format recording, and performs a disc formatting process according to the VR format.

The third initialization circuit 117 performs a file formatting process according to the UDF 2.5 for the AVCHD format recording, and performs a disc formatting process according to the DVD-video format.

The fourth initialization circuit 118 performs a file formatting process according to the UDF 2.5 for the AVCHD format recording, and performs a disc formatting process according to the VR format.

In the exemplary embodiment illustrated in FIG. 1, as described above, the four types of initialization circuits 115 to 118 which output the initialization data to perform the formatting using the combinations of the different file formats and disc formats are provided. The types of the formats are instructed from the microcomputer 113.

The microcomputer 113 performs a system control of the disc camcorder and includes a ROM which contains control codes and control data, and a RAM which temporarily stores various data (configurations of the ROM and the RAM are not shown). The microcomputer 113 performs an initialization process of the disc if the mounted disc is not initialized (blank disc) based on the disc information sent from the recording medium detection circuit 120.

Then, the microcomputer 113 generates a menu screen for the users to select the formatting type and outputs the generated data to the video signal processing circuit 103. Further, depending on the selection of the user, the microcomputer 113 outputs to the switching circuit 107 an instruction to switch the camera mode to either the SD mode or the HD mode. The item selected on the menu screen is input from the initialization request unit 112 into the microcomputer 113 as information about the formatting type and the formatting start.

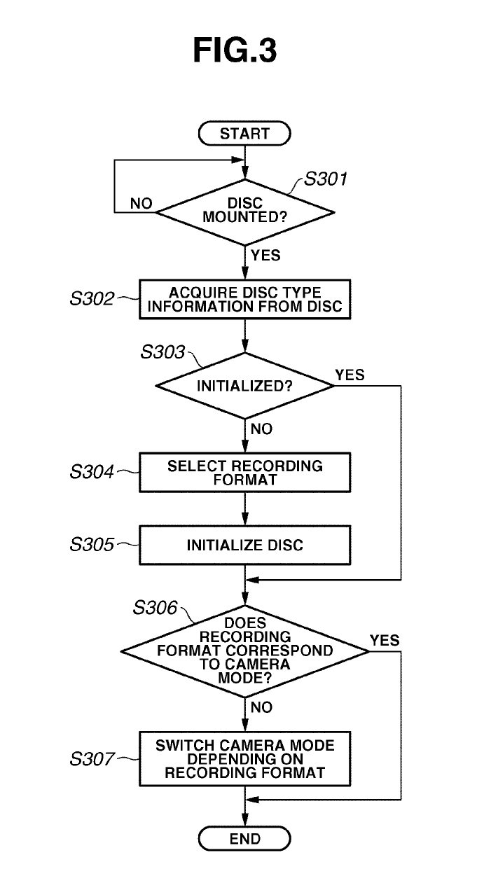

Next, an operation of the video camera 100 performed when a disc is newly mounted will be described with reference to the flowchart shown in FIG. 3. The process illustrated in FIG. 3 is executed by the microcomputer 113 which controls each unit of the camera 100.

Based on the disc information input by the recording medium detection circuit 120, it is determined whether the optical disc 111 is mounted (step S301). If it is determined that the optical disc 111 is not mounted (NO in step S301), the microcomputer 113 stands by until the mounting of disc is detected.

If the optical disc 111 is mounted (YES in step S301), the disc type information is acquired by the recording medium detection circuit 120 (step S302). The disc type information includes the file formatting type and the disc formatting type. In a case of the initialized optical disc 111, predetermined values can be obtained.

Then, based on the disc type information, it is determined whether the mounted optical disc 111 is already initialized (S303). If the disc is initialized (YES in step S303), the process proceeds to step S306.

If the disc is not yet initialized (NO in step S303), a screen for initialization is displayed on the display unit 106.

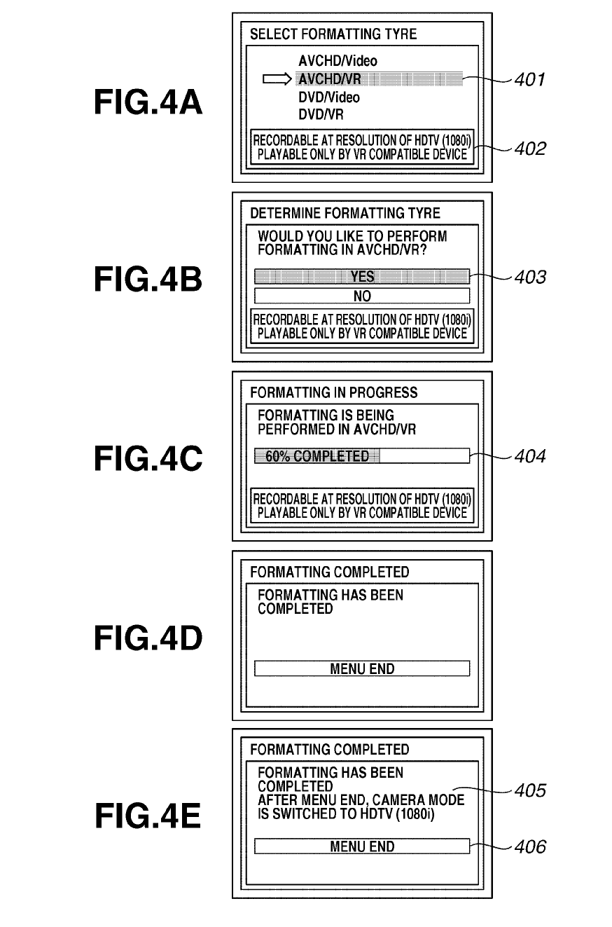

Exemplary examples of the menu screens at the time of formatting are shown in FIGS. 4A to 4E. FIG. 4A illustrates an exemplary example of a menu screen for selecting a formatting type. Items corresponding to the contents of the formatting are displayed, and a selection item 401 of the selected format is highlighted. Further, with respect to detailed information of the selected item, information about the camera mode type and the disc formatting type is displayed in a remarks column 402 to prevent the user from selecting an incorrect format which does not correspond to the intended purpose.

When the user selects a format (step S304) using the menu screen illustrated in FIG. 4A, according to the selected formatting type, an initialization process is performed on the optical disc 111 (step S305).

Then, first, a screen shown in FIG. 4B is displayed on the display unit 106. On the screen shown in FIG. 4B, the user selects whether to execute the formatting. The selected item, that is, a selection item 403 for determination of the execution, is highlighted similar to the formatting type selection.

If the start of the formatting is selected, the initialization request unit 112 outputs a formatting request of the optical disc 111 to the microcomputer 113. Then, the microcomputer 113 outputs the formatting type which is selected in step S304 to the selection circuit 114.

For example, as shown in FIG. 4A, if the VR format is selected in the AVCHD format, the fourth initialization circuit 118 is selected by the selection circuit 114. Then, a file formatting according to the UDF 2.5 and a disc formatting according to the VR format are executed.

Upon the execution of the initialization process, the screen shown in FIG. 4C is displayed on the display unit 106 and a status of the initialization process is sequentially shown together with process information 404. After the initialization process is completed, the process proceeds to step S306.

Then, information about a currently set camera mode which is selected by the operation unit 119 is compared to a camera mode corresponding to the formatting type information of the optical disc 111, and it is determined whether the camera modes match with each other as the comparison result (step S306).

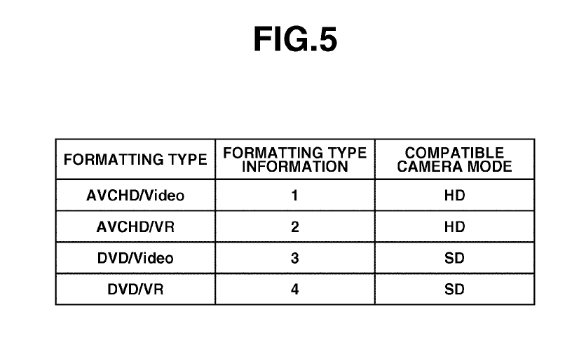

The formatting types and the corresponding camera modes are shown in FIG. 5.

For example, if the recording format of the optical disc 111 is the VR format in the AVCHD format, the camera mode which corresponds to the formatting type is the HD mode. Accordingly, if the HD mode is set by the camera mode switching circuit 119, the camera modes in step S306 match with each other as the comparison result.

If the comparison result is matching (YES in step S306), the process is completed. Then, on the display unit 106, after the formatting is completed, the screen shown in FIG. 4D is displayed.

If the comparison result is not matching (NO in step S306), the camera mode is switched to a camera mode corresponding to the recording format of the disc (step S307).

More specifically, an instruction to switch the circuit to a circuit which compresses a video signal of the camera mode corresponding to the recording format of the disc is issued to the switching circuit 107.

For example, if the formatting type information shown in FIG. 5 is “2”, the corresponding camera mode is the HD mode. Accordingly, an instruction is issued to the switching circuit 107 so that the video signal from the video signal processing circuit 103 is input to the first video signal compression circuit 108. Then, information about the switched camera mode is stored on the memory in the microcomputer 113.

In step S307, the screen shown in FIG. 4E is displayed on the display unit 106. Then, on the display screen of the FIG. 4E, a warning display 405 is displayed which notifies the user that the camera mode is switched after the formatting process is completed. When a menu end determination display 406 is selected and the menu end is determined, the switching of the camera modes is executed. Upon the completion of the camera mode switching, the process is finished.

With the above process, when the blank disc, which is not initialized as the optical disc 111, is mounted on the video camera 100 and the formatting process of the blank disc is executed, it is detected whether the camera mode corresponding to the recording formatting type matches with the camera mode set at the time. If the camera modes do not match with each other, the camera mode is switched to a camera mode corresponding to the formatting type. Accordingly, the user can implement the formatting process without considering the combination of the formatting type of the blank disc and the camera mode.

According to an exemplary embodiment, the formatting process that is performed when the blank disc is mounted has been described. However, a similar process can be performed when the formatting process is newly performed on the rewritable optical disc 111 which is already formatted.

Further, in an exemplary embodiment, the formatting type information is output from the microcomputer 113 to the selection circuit 114, and the information corresponds to the initialization circuit to be selected. On the other hand, the information about the file formatting type and the disc formatting type can be output from the microcomputer 113 to the selection circuit 114 respectively. Then, the selection circuit 114 can combine the obtained information, generate initialization data, and perform formatting of the optical disc 111.

### Second Exemplary Embodiment

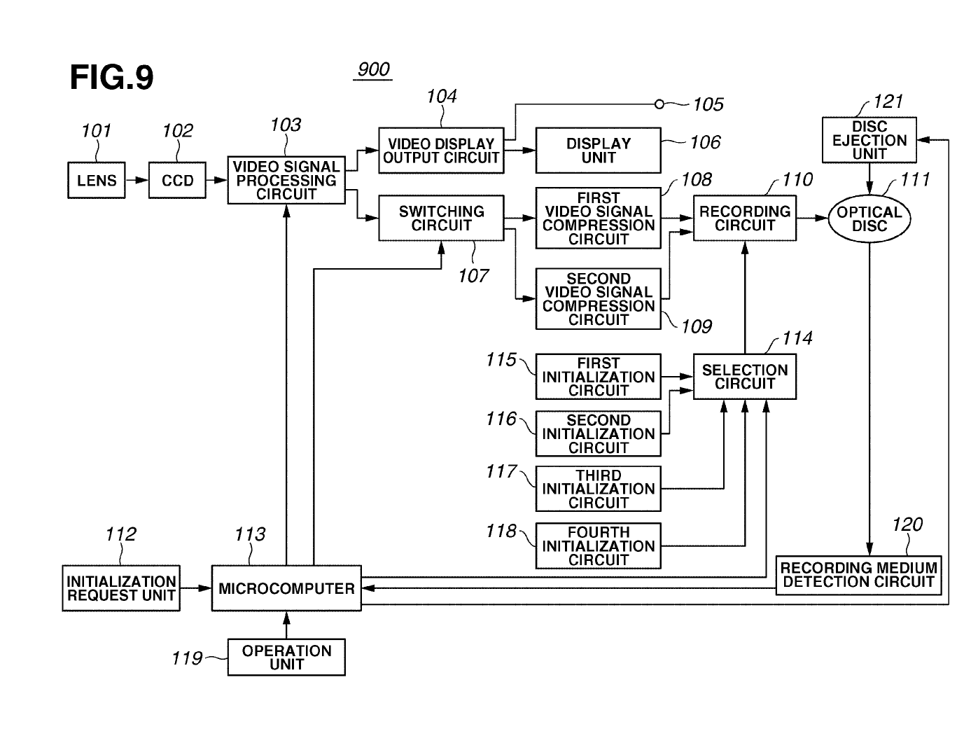

Next, a second exemplary embodiment of the present invention will be described. FIG. 9 is a view illustrating a configuration of a video camera 900 according to an exemplary embodiment. The video camera 900 illustrated in FIG. 9 has a similar structure to that of the video camera in FIG. 1. However, in FIG. 9, the video camera 900 differs from the configuration illustrated in FIG. 1 in that a disc eject unit 121 which automatically ejects the optical disc 111 is provided.

Further, in the second exemplary embodiment illustrated in FIG. 9, compared with the first exemplary embodiment, a process is different which is performed in a case where a camera mode of the video camera 900 does not correspond to a recording format of the disc after a disc initialization is performed or an initialized disc is mounted.

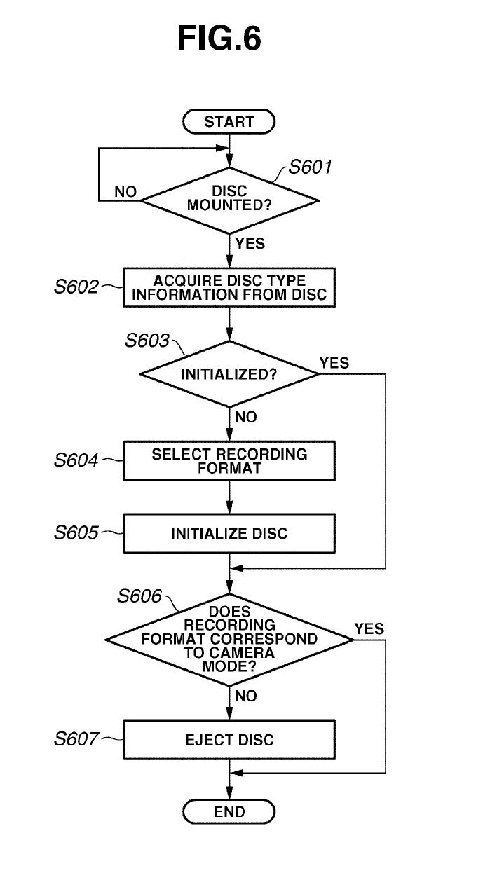

FIG. 6 is a flowchart illustrating the process performed in the video camera 900 when a disc is mounted according to an exemplary embodiment.

In FIG. 6, the process from step S601 to step S606 is similar to the process from step S301 to step S306 illustrated in FIG. 3. Accordingly, descriptions about the process will not be repeated.

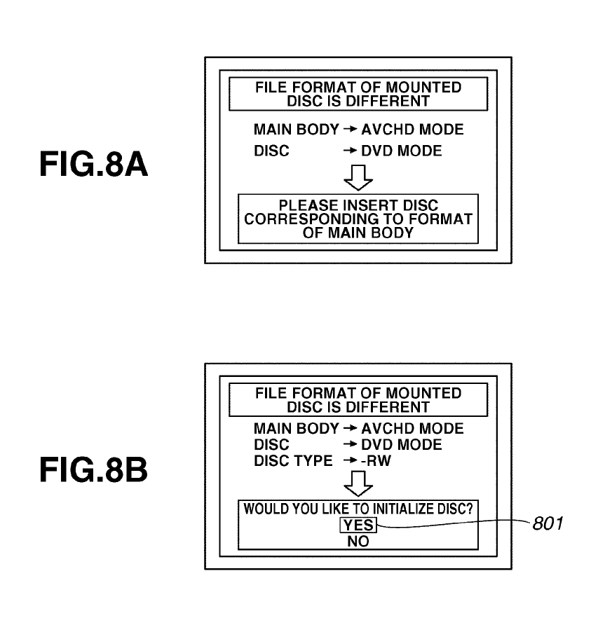

In an exemplary embodiment, in step S606, if the camera mode of the video camera 900 does not correspond to the recording format of the disc, the optical disc 111 which is currently mounted is ejected (step S607). Then, on the display unit 106, the screen shown in FIG. 8A is displayed.

### Third Exemplary Embodiment

Next, a third exemplary embodiment of the present invention will be described. In the third exemplary embodiment, the configuration of the video camera 100 and the basic recording operations are similar to the first exemplary embodiment.

In the third exemplary embodiment, compared with the first exemplary embodiment, a process is different which is performed in a case where a camera mode of the video camera 100 does not correspond to a recording format of the disc when an initialized disc is mounted.

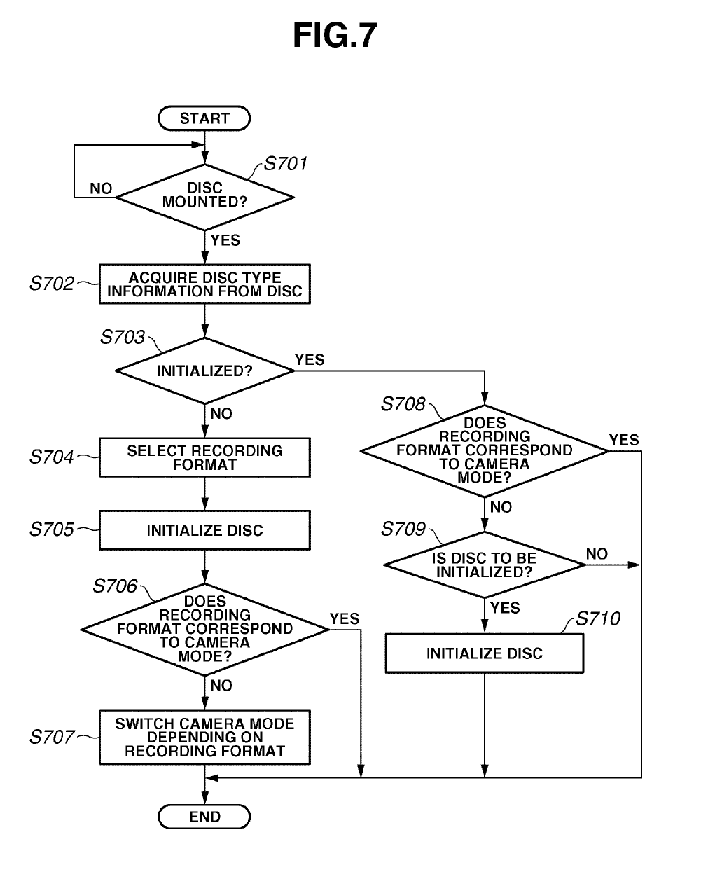

FIG. 7 is a flowchart illustrating a process performed in the video camera 100 when a disc is mounted according to the third exemplary embodiment.

In FIG. 7, the process from step S701 to step S707 is similar to the process from step S301 to step S307 illustrated in FIG. 3. Accordingly, descriptions about the process will be omitted.

In step S703 illustrated in FIG. 7, if an initialized disc is mounted, it is determined whether the camera mode of the video camera 100 corresponds to the recording format of the disc (step S708).

If the camera mode corresponds to the recording format of the disc (YES in step S708), the process is completed. If the camera mode of the video camera 100 does not correspond to the recording format of the disc (NO in step S708), the screen shown in FIG. 8B is displayed on the display unit 106 and it is inquired whether to initialize the optical disc 111 (step S709).

The user can select whether to execute the initialization process by operating the operation unit 119 and moving a cursor 801.

As a result, if the initialization of the optical disc 111 is instructed (YES in step S709), the initialization process of the optical disc 111 is executed according to the recording format corresponding to the current camera mode (step S710). In an exemplary embodiment, with respect to the respective SD mode and HD mode, either the DVD video format or the VR format can be selected as the recording format. Then, a screen that enables selecting of either the DVD video format or the VR format for the initialization is displayed on the display unit 106. Accordingly, the user can select the recording format using the screen.

If the user does not instruct the initialization of the optical disc 111 (NO in step S709), the processing ends.

In such a case, in the currently set camera mode, it is not possible to record a video signal on the optical disc 111. Therefore, the user has to switch the camera mode or replace the disc.

### Other Exemplary Embodiment

The above-described units included in the imaging apparatus and each step of the control method of the imaging apparatus according to the exemplary embodiments of the present invention can be implemented by executing a program stored on a RAM, a ROM, or the like in a computer. Accordingly, the program and the computer-readable recording medium that records the program constitute the present invention.

An aspect of the present invention can be applied, for example, to a system, an apparatus, a method, a program, or a storage medium. More specifically, an aspect of the present invention can be applied to a system including a plurality of devices or an apparatus consisting of a single device.

Further, a program (in the exemplary embodiments, the program corresponding to the flowchart shown in FIG. 3, 6, or 7) of software implementing the functions of the above-described exemplary embodiment can be directly, or remotely provided to a system or an apparatus. Then, a computer in the system or the apparatus achieves an aspect of the present invention by reading and executing the provided program code.

Accordingly, the program code itself installed on the computer to implement the functional processing of an aspect of the present invention, implements the functions of the present invention. That is, the computer program itself for implementing the functional processing of the present invention constitutes the present invention.

In such a case, if the function of the program is included, any style can be employed as the program, for example, a program implemented with an object code or an interpreter, and script data to be supplied to an operation system (OS) can be employed.

As the recording medium for supplying such program code, for example, a floppy disk, a hard disk, an optical disk, and a magneto-optical disk can be employed. Further, a magneto-optical disk (MO), a compact disk read-only memory (CD-ROM), a CD-recordable (CD-R), a CD-rewritable (CD-RW), a magnetic tape, a nonvolatile memory card, a ROM, and a DVD (a DVD-read only memory (DVD-ROM) and a DVD-R) can be employed.

In addition, the program can be supplied by connecting to a home page of the Internet using a browser of a client computer. Then, the program is supplied from the home page by downloading the computer program itself of the present invention or a compressed file including an automatic installation function into a recording medium such as a hard disk and the like.

Further, the program code constituting the program according to the present invention can be divided into a plurality of files, and each file can be downloaded from different home pages. That is, a world wide web (WWW) server which allows a plurality of users to download the program file for realizing the function processing of the present invention with the computer, is also included in the present invention.

Further, the program according to the present invention can be encrypted and stored on a storage medium such as a CD-ROM, and distributed to the users. A user who has cleared prescribed conditions is allowed to download key information for decrypting the cipher from a home page through the Internet. The user executes the encrypted program using the key information, and the program is installed on the computer. Thus, an aspect of the present invention can be realized.

Further, the function according to the embodiments described above can be implemented by executing the program code read by the computer. Furthermore, based on an instruction according to the program code, an OS and the like running on the computer executes a part or the whole of the actual processing, and thus, the function of the above-described embodiments can be realized.

Moreover, in another aspect of an exemplary embodiment of the present invention, the program code read from the storage medium is written on a memory which is provided in a function enhancing board inserted in the computer or in a function enhancing unit connected to the computer. Then, based on an instruction according to the program code, a central processing unit (CPU) or the like provided in the function enhancing board or in the function enhancing unit executes a part or the whole of the actual processing, and thus, the function of the above described embodiments can be realized.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2006-231013 filed on Aug. 28, 2006, and Japanese Patent Application No. 2006-231017 filed on Aug. 28, 2006, which are hereby incorporated by reference herein in their entirety.

What is claimed:

1. An imaging apparatus comprising:
an imaging unit configured to generate a first video signal according to a first video signal format, and a second video signal according to a second video signal format, wherein the imaging unit includes a first mode for generating the first video signal and a second mode for generating the second video signal;
an initialization format selection unit configured to select either a first recording format corresponding to the first video signal format or a second recording format corresponding to the second video signal format to initialize a recording medium;
an initialization unit configured to perform an initialization process of the recording medium according to the recording format selected by the initialization format selection unit;
a recording unit configured to record either the first video signal or the second video signal on the recording medium initialized by the initialization unit; and
a control unit configured to select one of the modes of the imaging unit depending on the recording format selected by the initialization format selection unit.

2. The imaging apparatus according to claim 1, wherein the initialization format selection unit selects one of the recording formats based on a user input.

3. The imaging apparatus according to claim 1, further comprising a mode selection unit configured to select either the first mode or the second mode,
wherein the control unit selects one the modes of the imaging unit so that the video signal format corresponding to the recording format selected by the initialization format selection unit matches with a video signal format generated in the mode selected by the mode selection unit.

4. The imaging apparatus according to claim 1, wherein the video signal recorded on the recording medium is managed as a file, and the recording format is determined in advance according to a combination of the file format for managing the video signal recorded on the recording medium, and one of the first video signal format and the second video signal format.

5. The imaging apparatus according to claim 1, wherein the first video signal and the second video signal are different in resolutions.

6. The imaging apparatus according to claim 1, wherein the imaging unit includes an imaging section configured to capture an image of an object and output a video signal, and a coding unit that codes the video signal output from the imaging section, and the coding unit includes a first coding section configured to code the video signal according to a coding format corresponding to the first video signal format and output the first video signal, and a second coding section configured to code the video signal according to a coding format corresponding to the second video signal format and output the second video signal.

7. An imaging apparatus comprising:
an imaging unit configured to generate video signals according to a plurality of types of video signal formats;
a video selection unit configured to select one of video signal types;
a recording format detection unit configured to detect a recording format of a recording medium initialized according to any one of recording formats corresponding to the plurality of video signal types;
a recording unit configured to record the video signal type selected by the video selection unit out of the plurality of recording signal types generated by the imaging unit, on the recording medium; and
a control unit configured to control the imaging unit so that a video signal of a type recordable in the recording format of the recording medium is generated in a case where the recording format detected by the recording format detection unit cannot record the video signal of the type selected by the video selection unit.

8. The imaging apparatus according to claim 7, wherein the video signal recorded on the recording medium is managed as a file, and the recording format is determined in advance according to a combination of the file format for managing the video signal recorded on the recording medium, and the plurality of the video signal types.

9. The imaging apparatus according to claim 7, wherein the plurality of the video signal types are different in resolutions.

10. The imaging apparatus according to claim 7, wherein the imaging unit includes an imaging section configured to capture an image of an object and output a video signal, and a coding unit configured to code the video signal output from the imaging section according to a coding format corresponding to the plurality of video signal formats and generate the plurality of video signal types.

11. An imaging apparatus comprising:
an imaging unit configured to generate video signals according to a plurality of video signal formats;
a video selection unit configured to select one of video signal types;
a recording format detection unit configured to detect a recording format of a recording medium initialized according to any one of recording formats corresponding to the plurality of video signal types;
a recording unit configured to record the video signal of the type selected out of the plurality of recording signal types generated by the imaging unit, on the recording medium;
an ejection unit configured to eject the recording medium out of the apparatus; and
a control unit configured to control the ejection unit to eject the recording medium in a case where the recording format detected by the recording format detection unit cannot record the video signal of the type selected by the video selection unit.

12. An imaging apparatus comprising:
an imaging unit configured to generate video signals according to a plurality of video signal formats;
a video selection unit configured to select one of video signal types;
a recording format detection unit configured to detect a recording format of a recording medium initialized according to any one of recording formats corresponding to the plurality of video signal types;
a recording unit configured to record the video signal of the type selected out of the plurality of recording signal types generated by the imaging unit, on the recording medium;
an initialization unit configured to initialize the recording medium according to any one of recording formats corresponding to the plurality of video signal types; and
a control unit configured to control the initialization unit so that the initialization unit performs initialization in a recording format which can record the video signal of the type selected by the selection unit in a case where the recording format detected by the recording format detection unit cannot record the video signal of the type selected by the video selection unit.
